(19) United States
(12) Patent Application Publication
(10) Pub. No.: US 2023/0318196 A1
(43) Pub. Date: Oct. 5, 2023

(54) REFLECTOR ANTENNA APPARATUS

(71) Applicant: Mitsubishi Electric Corporation, Tokyo (JP)

(72) Inventors: Hiromasa NAKAJIMA, Tokyo (JP); Shinichi YAMAMOTO, Tokyo (JP); Michio TAKIKAWA, Tokyo (JP)

(73) Assignee: Mitsubishi Electric Corporation, Tokyo (JP)

(21) Appl. No.: 18/207,245

(22) Filed: Jun. 8, 2023

Related U.S. Application Data
(63) Continuation of application No. PCT/JP2021/007233, filed on Feb. 26, 2021.

(51) Int. Cl. H01Q 15/16; H01Q 3/01

(52) U.S. Cl. CPC H01Q 15/16; H01Q 3/01

(57) ABSTRACT

A reflector antenna apparatus includes: a radiator that emits a radio wave; a reflector that reflects the radio wave emitted from the radiator, a shape of the reflector being changeable; a support structure supporting the reflector, the support structure being connected to at least a part of an outer periphery of the reflector and including at least two flexible support members capable of following a change in the shape of the reflector; an injection device that injects a fluid into the at least two support members; and a coupling that couples the reflector and the at least two support members. In a deployed state in which the at least two support members are filled with the fluid, the reflector is configured to form a curved surface shape in which the reflector is not curved in a first direction and is curved in a second direction orthogonal to the first direction.

### CROSS REFERENCE TO RELATED APPLICATION

This application is a Continuation of PCT International Application No. PCT/JP2021/007233, filed on Feb. 26, 2021, which is hereby expressly incorporated by reference into the present application.

### TECHNICAL FIELD

The present disclosure relates to a reflector antenna apparatus.

### BACKGROUND ART

Conventionally, Non-Patent Literature 1 below discloses a method as a method for deploying a reflector antenna. Non-Patent Literature 1 discloses a reflector antenna including a reflector furled into a tubular shape to be stowed, and hinged chains disposed at opposite ends of the reflector. Non-Patent Literature 1 discloses a method for deploying the reflector by mechanically driving the hinged chain and forming the reflector antenna.

### CITATION LIST

### Non-Patent Literature

Non-Patent Literature 1: Y. Rahmat-Samii et al., “Advanced precipitation Radar antenna: array-fed offset membrane cylindrical reflector antenna,” in IEEE Transactions on Antennas and Propagation, vol. 53, no. 8, pp. 2503-2515, August 2005, doi:10.1109/TAP.2005.852599.

### SUMMARY OF INVENTION

### Technical Problem

According to the technique of Patent Literature 1, there is a problem that a mechanical drive unit is required for a deployment mechanism for deploying the reflector.

The present disclosure has been made in order to solve such a problem, and an object of an aspect of embodiments is to provide a reflector antenna apparatus capable of deploying a reflector without using a mechanical drive unit.

### Solution to Problem

According to an aspect of a reflector antenna apparatus according to an embodiment, a reflector antenna apparatus includes: at least one primary radiator that emits a radio wave; a reflector that reflects the radio wave emitted from the at least one primary radiator, a shape of the reflector being changeable; a support structure that supports the reflector, the support structure being connected to at least a part of an outer periphery of the reflector and including at least two flexible support members capable of following a change in the shape of the reflector; an injection device that injects a fluid into the at least two support members; and a coupling that couples that couples the reflector and the at least two support members. In a deployed state in which the at least two support members are filled with the fluid, the reflector is configured to form a curved surface shape in which the reflector is not curved in a first direction and is curved in a second direction orthogonal to the first direction.

### Advantageous Effects of Invention

According to an aspect of a reflector antenna apparatus according to the embodiments, a reflector can be deployed without using a mechanical drive unit.

### BRIEF DESCRIPTION OF DRAWINGS

FIG. 1 is a perspective view of a reflector antenna apparatus according to a first embodiment.

FIG. 2 is a front view of the reflector antenna apparatus according to the first embodiment.

FIG. 3 is a right side view of the reflector antenna apparatus according to the first embodiment.

FIG. 4 is a diagram illustrating a state of a reflector and a support structure according to the first embodiment at the time of contraction.

FIG. 5 is a diagram illustrating a state in the middle of deployment of the reflector and the support structure according to the first embodiment.

FIG. 6 is a detailed diagram of a side surface of the reflector.

FIG. 7 is a detailed diagram of a side surface of the reflector.

FIG. 8 is a detailed diagram of a side surface of the reflector.

FIG. 9 is a diagram illustrating a coupling between the reflector and the support structure in detail.

FIG. 10 is a diagram illustrating a coupling between the reflector and the support structure in detail.

FIG. 11 is a diagram illustrating a coupling between the reflector and the support structure in detail.

FIG. 12 is a diagram illustrating a configuration example of the support structure.

FIG. 13 is a diagram illustrating another configuration example of the support structure.

FIG. 14 is a diagram illustrating another configuration example of the support structure.

FIG. 15 is a diagram illustrating the shape of the support structure.

FIG. 16 is a perspective view of a mode of a reflector antenna apparatus according to a second embodiment at the time of deployment.

FIG. 17 is a perspective view of a mode of the reflector antenna apparatus according to the second embodiment at the time of contraction.

FIG. 18 is a diagram illustrating an example of using a plurality of horn antennas as a primary radiator.

FIG. 19 is a diagram illustrating an example of using a plurality of patch antennas as the primary radiator.

### DESCRIPTION OF EMBODIMENTS

Hereinafter, various embodiments according to the present disclosure will be described in detail with reference to the drawings. Note that constituent elements denoted by the same reference numeral throughout the drawings have the same or similar configuration or the same or similar function.

### First Embodiment

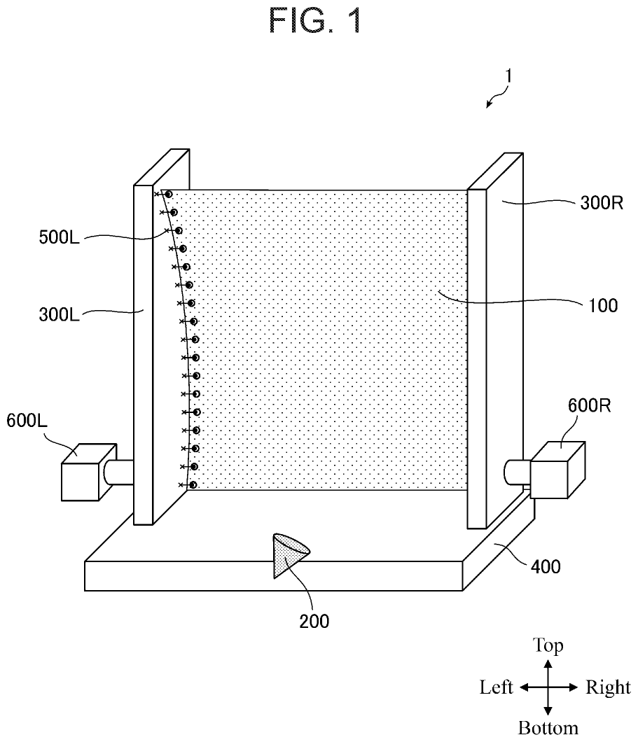

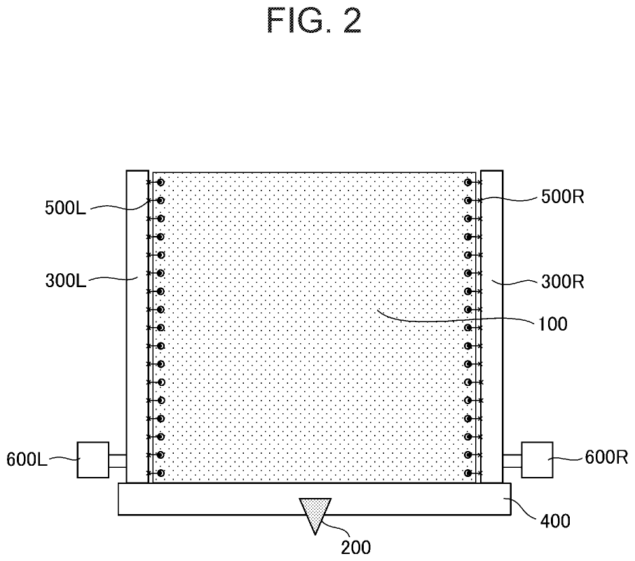

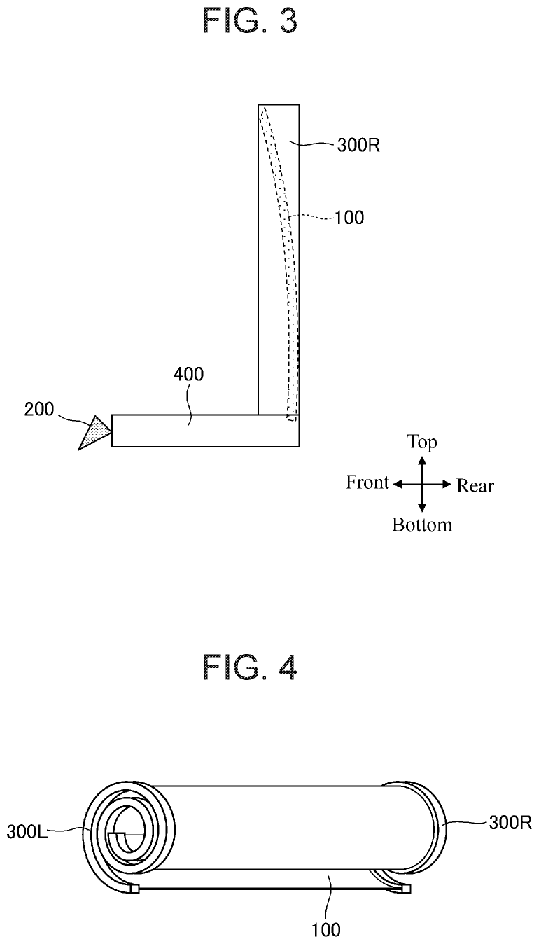

Hereinafter, a reflector antenna apparatus 1 according to a first embodiment of the present disclosure will be described with reference to FIGS. 1 to 15. First, with reference to FIGS. 1 to 3, an overall configuration of the reflector antenna apparatus 1 will be described on the basis of a state in which the reflector antenna apparatus 1 is deployed. FIG. 1 is a perspective view of the reflector antenna apparatus 1, FIG. 2 is a front view of the reflector antenna apparatus 1, and FIG. 3 is a right side view of the reflector antenna apparatus 1.

As illustrated in FIG. 1 or 2, the reflector antenna apparatus 1 includes: a reflector 100 that reflects a radio wave; a primary radiator 200 that emits a radio wave; a support member 300L and a support member 300R constituting a support structure 300 that supports the reflector 100; a base 400 that supports the support member 300L and the support member 300R; a coupling 500L that couples the support member 300L and the reflector 100; a coupling 500R that couples the support member 300R and the reflector 100; an injection device 600L that injects a fluid such as a gas or a liquid into the support member 300L, and an injection device 600R that injects the fluid into the support member 300R. The size of the reflector 100 is, for example, 5 m×5 m in length and width, but may be another size.

As illustrated in FIG. 1 or 3, the reflector 100 has a shape in which a cross-sectional view of the reflector 100 is straight in one direction (hereinafter, referred to as “first direction”) and the reflector 100 has a cylindrical surface curved so as to have a non-zero curvature in a direction (hereinafter, referred to as “second direction”) orthogonal to the first direction. In other words, the reflector 100 has a shape in which the reflector 100 is not curved in the first direction but is curved in the second direction. The reflector 100 may have a curvature in such a manner that a curve in the second direction is a parabola. That is, the reflector 100 may have a parabolic cylinder shape. Note that the first direction is a left/right direction in FIG. 1, and the second direction is a top/bottom direction in FIG. 1.

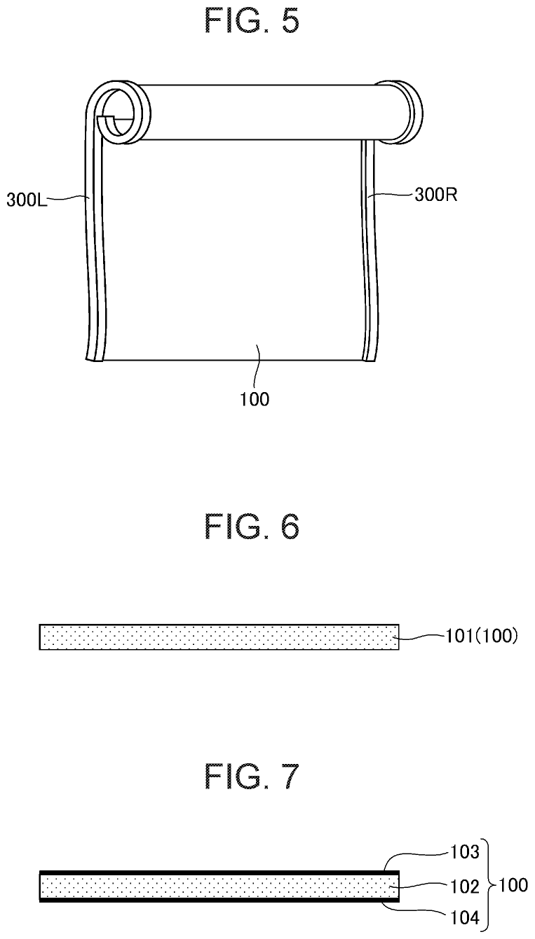

Here, with reference to FIGS. 4 and 5, forms of the reflector antenna apparatus 1 at the time of contraction and in the middle of deployment will be described. FIG. 4 is a diagram illustrating a state (contracted state) of the reflector 100 and the support members 300L and 300R at the time of contraction, and FIG. 5 is a diagram illustrating a state of the reflector 100 and the support members 300L and 300R in the middle of deployment. As illustrated in FIG. 4, the reflector 100 and the support members 300L and 300R are rolled into a tubular shape as a whole by being wound in the second direction. As described later, the reflector 100 and the support members 300L and 300R are made of flexible members, and the support members 300L and 300R are coupled to the reflector 100 by the corresponding couplings 500L and 500R, respectively. In addition, the inside of the support members 300L and 300R is hollow, and the support members 300L and 300R expand by a fluid being injected into the support members 300L and 300R. Therefore, when the fluid is injected into the support members 300L and 300R at the time of contraction in FIG. 4, the support members 300L and 300R expand as illustrated in FIG. 5, and the reflector 100 and the support members 300L and 300R are integrally deployed. By the fluid being further injected into the support members 300L and 300R, the support members 300L and 300R expand to a state at the time of deployment (deployed state) illustrated in FIG. 1. Note that, in FIGS. 4 and 5, other components such as the base 400 is not illustrated in order to describe in detail a change in state of the reflector 100 and the support members 300L and 300R from the time of contraction to the time of deployment.

(Primary Radiator)

Hereinafter, main components of the reflector antenna apparatus 1 will be described in detail. The primary radiator 200 is supported by a stay (not illustrated) connected to the base 400, and emits a radio wave toward the reflector 100. The primary radiator 200 includes one or more primary radiators such as a horn antenna, a slot antenna, and a patch antenna. The primary radiators 200 may be arranged parallel to the first direction. When the reflector 100 has a parabolic cylinder shape in the deployed state, the primary radiators 200 may be arranged along a focal line of the reflector 100.

(Reflector)

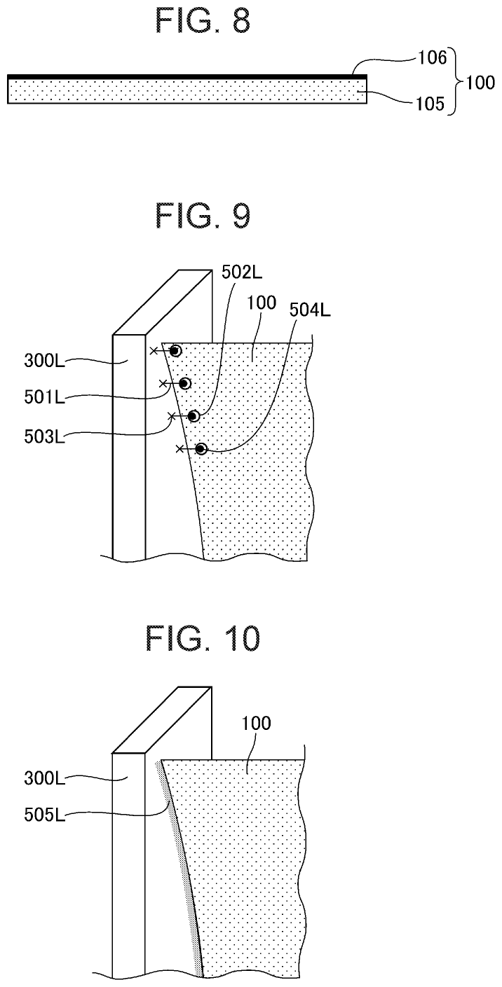

The reflector 100 is a reflector that reflects a radio wave emitted from the primary radiator 200, and is made of a material capable of changing the shape of the reflector 100. Here, with reference to FIGS. 6 to 8, a layer configuration and a material of the reflector 100 will be described. FIGS. 6 to 8 are detailed diagrams of a side surface of the reflector 100. The reflector 100 is made of a flexible sheet-like material in such a manner that the support members 300L and 300R can be deployed from a contracted state to a stretched state. As illustrated in FIG. 6, the reflector 100 may be constituted only by one layer of a flexible material layer 101 having conductivity. In addition, as illustrated in FIG. 7, the reflector 100 may be constituted by three layers in which conductive material layers 103 and 104 having conductivity are disposed on both surfaces of a flexible material layer 102, respectively. In addition, as illustrated in FIG. 8, the reflector 100 may be constituted by two layers in which a conductive material layer 106 is disposed only on one surface of a flexible material layer 105.

(Support Structure)

The support structure 300 is a support structure that supports the reflector 100, and is constituted by a plurality of support members. The support structure 300 supports the reflector 100 by being coupled to at least a part of an outer periphery of the reflector 100. In the embodiment illustrated in FIG. 1, the support structure 300 includes the support members 300L and 300R and supports two sides of the reflector 100. At least a part of the support structure 300 is disposed on the base 400. The support member constituting the support structure 300 has one or more injection ports (not illustrated) for injecting a fluid, and the support member is deployed by the fluid being injected from the injection device 600 through the injection port. Examples of the fluid include a gas and a liquid.

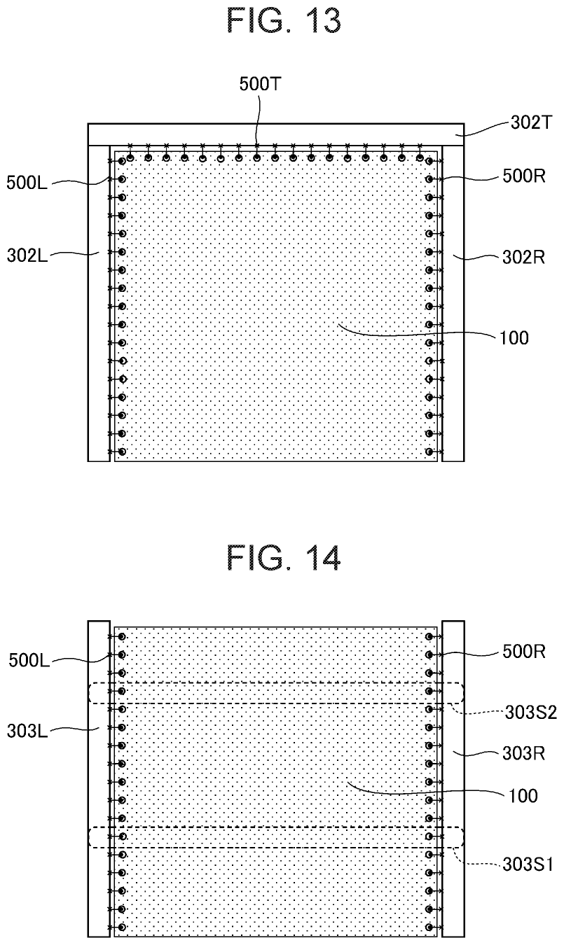

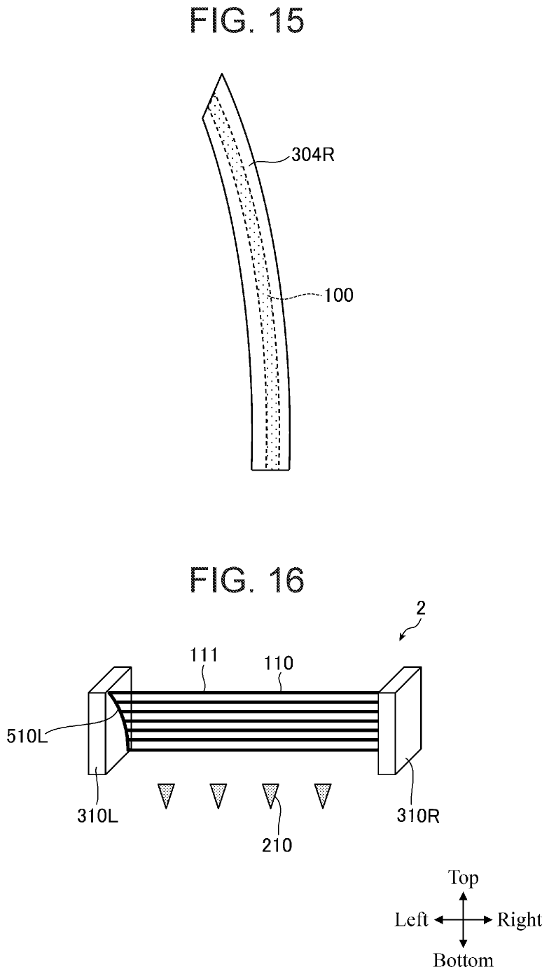

Here, with reference to FIGS. 12 to 15, various configuration examples of the support structure 300 or the shape of the support structure 300 will be described. As illustrated in FIG. 12, the support structure 300 may include two rectangular parallelepiped support members 301L and 301R that support two sides of the reflector 100. In addition, as illustrated in FIG. 13, the support structure 300 may include three rectangular parallelepiped support members 302L, 302T, and 302R that support three sides of the reflector 100. In addition, as illustrated in FIG. 14, the support structure 300 may have a ladder-like structure. That is, the support structure 300 may include support members 303L and 303R disposed on the left and right, and support members 303S1 and 303S2 extending in the left and right direction and connecting the support members 303L and 303R as a ladder step. In addition, as illustrated in FIG. 15, the shape of a side surface of the support member constituting the support structure 300 may have a curvature along the shape of a side surface of the reflector 100. That is, the support structure 300 may include a support member 304R and a support member 304L (not illustrated) corresponding to the support member 304R.

In order to maintain the shape of the support structure 300 after deployment, a material for maintaining the shape may be applied to a surface of the support member constituting the support structure 300. Examples of such a shape maintaining material include an ultraviolet curable resin that is cured by an ultraviolet ray.

As described above, the support structure 300 is an inflatable structure. Therefore, by using the support structure 300, the reflector 100 can be deployed without using a mechanical drive unit as a deployment mechanism of the reflector 100. Since the mechanical drive unit is not used, a deployment mechanism of the reflector 100 can be made smaller and lighter than that in the prior art.

(Coupling)

The coupling 500 is a structure portion that couples the reflector 100 and the support structure 300. The reflector 100 and the support structure 300 are coupled by the coupling 500 in such a manner that the reflector 100 has a predetermined curved surface shape at the time of deployment. In the mode illustrated in FIGS. 1 and 2, the coupling 500L couples the reflector 100 and the support member 300L, and the coupling 500R couples the reflector 100 and the support member 300R.

Here, with reference to FIGS. 9 to 11, various modes of the coupling 500 will be described. FIG. 9 illustrates an example in which a plurality of string-like members SOIL having a string shape is used as the coupling 500. As illustrated in FIG. 9, in the support member 300L, a plurality of connecting portions 503L for connecting the support member 300L and the string-like member SOIL is disposed. In addition, the reflector 100 has a plurality of holes 502L, and each of the holes 502L has a connecting portion 504L for connecting the string-like member SOIL and the reflector 100. The reflector 100 and the support member 300L are connected by the string-like member SOIL being connected to the connecting portion 503L and the connecting portion 504L corresponding to the connecting portion 503L.

FIG. 10 illustrates an example in which an adhesive 505L is used as the coupling 500. As illustrated in FIG. 10, the reflector 100 and the support member 300L may be connected by the adhesive 505L.

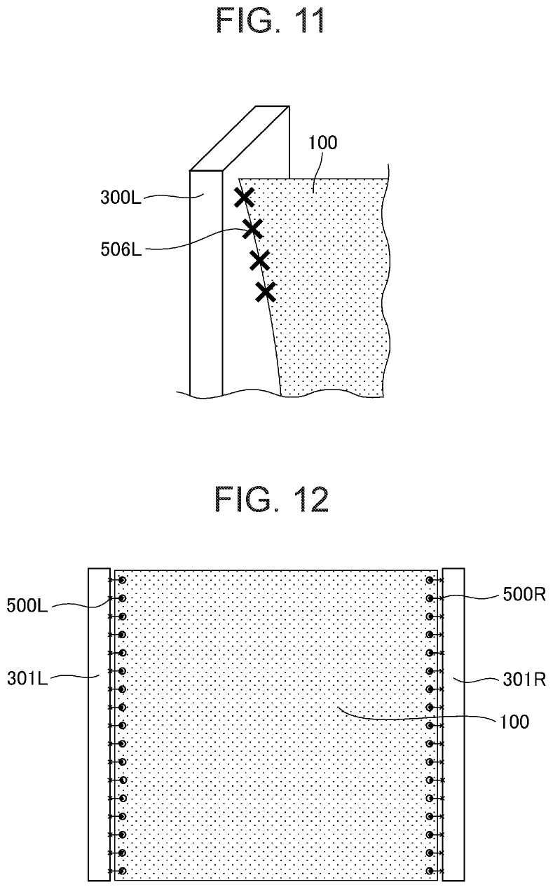

FIG. 11 illustrates an example in which a plurality of sewn parts 506L is used as the coupling 500. As illustrated in FIG. 11, the reflector 100 and the support member 300L may be coupled by being sewn at a plurality of places.

Note that, in the above description, the state of the reflector 100 at the time of contraction has been described as a tubular state, but is not limited to the tubular state. For example, the reflector 100 may be folded and contracted. As another example, the reflector 100 may be folded in a bellows shape and contracted. In addition, filling of the support structure 300 with a fluid is not limited to a case where the support structure 300 is filled with the fluid by injecting the fluid from the injection device 600. For example, in outer space, by expanding a fluid inside the support structure 300 due to a change in an external environment such as atmospheric pressure or temperature, the support structure 300 may be filled with the fluid.

### Second Embodiment

Hereinafter, a reflector antenna apparatus 2 according to a second embodiment of the present disclosure will be described with reference to FIGS. 16 to 19. A difference from the first embodiment will be mainly described, and description of points overlapping with the first embodiment will be omitted. FIG. 16 is a perspective view of a mode of the reflector antenna apparatus 2 according to the second embodiment at the time of deployment after the reflector antenna apparatus 2 is deployed. As illustrated in FIG. 16, the reflector antenna apparatus 2 includes a reflector 110, a plurality of primary radiators 210, support members 310L and 310R constituting a support structure 310, and a coupling 510 between the reflector 110 and the support structure 310. Note that a base on which the support members 310L and 310R are placed is not illustrated.

The reflector 110 is formed by combining conductive plates 111 having conductivity, and is configured to be able to change the shape of the reflector 110. In addition, the support structure 310 expands by filling the inside of the support structure 310 with a fluid such as a gas or a liquid, and supports the conductive plates 111. The conductive plates 111 and the support structure 310 may be connected by being tied with a plurality of string-like members. In addition, the conductive plates 111 and the support structure 310 may be connected by another method such as an adhesive, vapor deposition, or sewing.

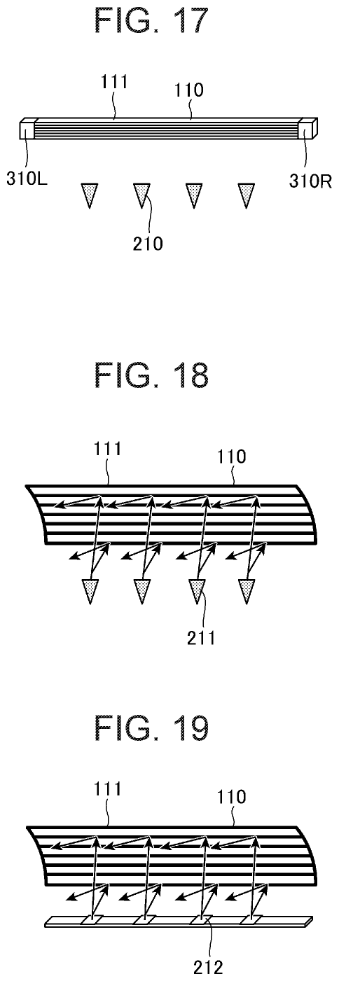

FIG. 17 is a perspective view of a mode of the reflector antenna apparatus 2 according to the second embodiment of the present disclosure at the time of contraction. As illustrated in FIG. 17, the reflector 110 is contracted by the plurality of conductive plates 111 being overlapped with each other.

FIG. 18 illustrates an example of using a plurality of horn antennas 211 as the primary radiators 210. By giving any phase difference between the horn antennas 211, beam scanning can be performed.

FIG. 19 illustrates an example of using a plurality of patch antennas 212 as the primary radiators 210. By giving any phase difference between the patch antennas 212, beam scanning can be performed.

Note that the shape of the conductive plate 111 may be a flat plate or a shape having a curvature. In addition, in order to expand the support structure 310, a gas may be injected from the outside, or an effect that a gas or a liquid that has been injected in advance expands due to a change in an external environment such as atmospheric pressure or temperature may be used. In addition, the example in which the horn antennas and the patch antennas are used as the primary radiators 210 has been described, but other antennas may be used. In addition, the number of the primary radiators 210 may be one or more.

<Supplementary Note>

Some of the various aspects of the embodiments described above are summarized below.

(Supplementary Note 1)

A reflector antenna apparatus (1, 2) according to supplementary note 1 includes: at least one primary radiator (200; 210) that emits a radio wave; a reflector (100; 110) that reflects the radio wave emitted from the at least one primary radiator, a shape of the reflector being changeable; a support structure (300; 310) that supports the reflector, the support structure being connected to at least a part of an outer periphery of the reflector and including at least two flexible support members (300L, 300R, 300T; 310L, 310R) capable of following a change in the shape of the reflector; an injection device (600L, 600R) that injects a fluid into the at least two support members; and a coupling (500; 510) that couples the reflector and the at least two support members. In a deployed state in which the at least two support members are filled with the fluid, the reflector is configured to form a curved surface shape in which the reflector is not curved in a first direction and is curved in a second direction orthogonal to the first direction.

(Supplementary Note 2)

A reflector antenna apparatus according to supplementary note 2 is the reflector antenna apparatus according to supplementary note 1, in which the curved surface shape is a parabolic cylinder shape.

(Supplementary Note 3)

A reflector antenna apparatus according to supplementary note 3 is the reflector antenna apparatus according to supplementary note 1 or 2, in which two support members included in the at least two support members are arranged in parallel to the second direction.

(Supplementary Note 4)

A reflector antenna apparatus according to supplementary note 4 is the reflector antenna apparatus according to supplementary note 3, in which each of the two support members arranged in parallel to the second direction has a curved surface shape along a curved surface of the reflector in the deployed state.

(Supplementary Note 5)

A reflector antenna apparatus according to supplementary note 5 is the reflector antenna apparatus according to any one of supplementary notes 1 to 4, in which the support structure has a ladder-like shape in the deployed state.

(Supplementary Note 6)

A reflector antenna apparatus according to supplementary note 6 is the reflector antenna apparatus according to any one of supplementary notes 1 to 5, in which the fluid is a gas or a liquid.

(Supplementary Note 7)

A reflector antenna apparatus according to supplementary note 7 is the reflector antenna apparatus according to any one of supplementary notes 1 to 6, in which the reflector and the support structure are rounded into a tubular shape in a contracted state in which the at least two support members are not filled with the fluid.

(Supplementary Note 8)

A reflector antenna apparatus according to supplementary note 8 is the reflector antenna apparatus according to any one of supplementary notes 1 to 6, in which the reflector and the support structure are folded in a contracted state in which the at least two support members are not filled with the fluid.

(Supplementary Note 9)

A reflector antenna apparatus according to supplementary note 9 is the reflector antenna apparatus according to any one of supplementary notes 1 to 8, in which the reflector is a flexible sheet-like reflector (100) that can be rolled into a tubular shape.

(Supplementary Note 10)

A reflector antenna apparatus according to supplementary note 10 is the reflector antenna apparatus according to any one of supplementary notes 1 to 8, in which the reflector (110) includes a plurality of conductive plates (111).

(Supplementary Note 11)

A reflector antenna apparatus according to supplementary note 11 is the reflector antenna apparatus according to any one of supplementary notes 1 to 10, in which the at least one primary radiator includes a plurality of horn antennas.

(Supplementary Note 12)

A reflector antenna apparatus according to supplementary note 12 is the reflector antenna apparatus according to any one of supplementary notes 1 to 10, in which the at least one primary radiator includes a plurality of slot antennas.

(Supplementary Note 13)

A reflector antenna apparatus according to supplementary note 13 is the reflector antenna apparatus according to any one of supplementary notes 1 to 10, in which the at least one primary radiator includes a plurality of patch antennas.

Note that the embodiments can be combined, and each of the embodiments can be appropriately modified or omitted.

### INDUSTRIAL APPLICABILITY

The reflector antenna apparatus according to the present disclosure is deployed by an inflatable mechanism, and therefore can be made lighter. Therefore, for example, the reflector antenna apparatus according to the present disclosure is suitable for being mounted on a satellite and used in outer space.

### REFERENCE SIGNS LIST

1: reflector antenna apparatus, 2: reflector antenna apparatus, 100: reflector, 101: flexible material layer, 102: flexible material layer, 103: conductive material layer, 104: conductive material layer, 105: flexible material layer, 106: conductive material layer, 110: reflector, 111: conductive plate, 200: primary radiator, 210: primary radiator, 211: horn antenna, 212: patch antenna, 300: support structure, 300L: support member, 300R: support member, 301L: support member, 302L: support member, 302T: support member, 303L: support member, 303S1: support member, 304L: support member, 304R: support member, 310: support structure, 310L: support member, 400: base, 500: coupling, 500L: coupling, 500R: coupling, 501: string-like member, SOIL: string-like member, 502L: hole, 503L: connecting portion, 504L: connecting portion, 505L: adhesive, 506L: sewn part, 510: coupling, 600: injection device, 600L: injection device, 600R: injection device

1. A reflector antenna apparatus comprising:
at least one primary radiator to emit a radio wave;
a reflector to reflect the radio wave emitted from the at least one primary radiator, a shape of the reflector being changeable;
a support structure to support the reflector, the support structure being connected to at least a part of an outer periphery of the reflector and including at least two flexible support members capable of following a change in the shape of the reflector;
an injection device to inject a fluid into the at least two support members; and
a coupling to couple the reflector and the at least two support members, wherein
in a deployed state in which the at least two support members are filled with the fluid, the reflector is configured to form a curved surface shape in which the reflector is not curved in a first direction and is curved in a second direction orthogonal to the first direction.

2. The reflector antenna apparatus according to claim 1, wherein the curved surface shape is a parabolic cylinder shape.

3. The reflector antenna apparatus according to claim 2, wherein two support members included in the at least two support members are arranged in parallel to the second direction.

4. The reflector antenna apparatus according to claim 3, wherein each of the two support members arranged in parallel to the second direction has a curved surface shape along a curved surface of the reflector in the deployed state.

5. The reflector antenna apparatus according to claim 1, wherein the support structure has a ladder-like shape in the deployed state.

6. The reflector antenna apparatus according to claim 1, wherein the fluid is a gas or a liquid.

7. The reflector antenna apparatus according to claim 1, wherein the reflector and the support structure are rounded into a tubular shape in a contracted state in which the at least two support members are not filled with the fluid.

8. The reflector antenna apparatus according to claim 1, wherein the reflector and the support structure are folded in a contracted state in which the at least two support members are not filled with the fluid.

9. The reflector antenna apparatus according to claim 1, wherein the reflector is a flexible sheet-like reflector that can be rolled into a tubular shape.

10. The reflector antenna apparatus according to claim 1, wherein the reflector includes a plurality of conductive plates.

11. The reflector antenna apparatus according to claim 1, wherein the at least one primary radiator includes a plurality of horn antennas.

12. The reflector antenna apparatus according to claim 1, wherein the at least one primary radiator includes a plurality of slot antennas.

13. The reflector antenna apparatus according to claim 1, wherein the at least one primary radiator includes a plurality of patch antennas.

14. The reflector antenna apparatus according to claim 2, wherein the at least one primary radiator includes a plurality of horn antennas.

15. The reflector antenna apparatus according to claim 2, wherein the at least one primary radiator includes a plurality of slot antennas.

16. The reflector antenna apparatus according to claim 2, wherein the at least one primary radiator includes a plurality of patch antennas.

17. The reflector antenna apparatus according to claim 3, wherein the at least one primary radiator includes a plurality of horn antennas.

18. The reflector antenna apparatus according to claim 3, wherein the at least one primary radiator includes a plurality of slot antennas.

19. The reflector antenna apparatus according to claim 3, wherein the at least one primary radiator includes a plurality of patch antennas.
